(19) United States
(12) Patent Application Publication
(10) Pub. No.: US 2026/0120364 A1
(43) Pub. Date: Apr. 30, 2026

(54) MEDIA CONTENT GENERATION

(71) Applicant: Beijing Zitiao Network Technology Co., Ltd., Haidian District (CN)

(72) Inventors: Jiahui Yang, Beijing (CN); Nuomeng Zhang, Beijing (CN)

(21) Appl. No.: 19/372,013

(22) Filed: Oct. 28, 2025

(30) Foreign Application Priority Data
Oct. 28, 2024 (WO) PCT/CN2024/127919

(51) Int. Cl. G06T 11/60; G06T 5/50; G06T 7/194

(52) U.S. Cl. CPC G06T 11/60; G06T 5/50; G06T 7/194; G06T 2207/20221

(57) ABSTRACT

Embodiments of the disclosure relates to a method, apparatus, device, and storage medium for generating a media content. The method includes: determining a set of reference media contents for media content generation, the set of reference media contents being determined from a media library associated with a user; and presenting a target media content generated based on the set of reference media contents, the target media content comprising at least one foreground element superimposed on a background image, wherein a foreground element comprises an image segment determined by segmenting a corresponding reference media content of the set of reference media contents. In this way, the embodiments of the present disclosure may improve the quality and efficiency of media content generation.

### CROSS-REFERENCE

This application claims priority to International Application No. PCT/CN2024/127919, filed on Oct. 28, 2024 and entitled ‘METHOD, APPARATUS, DEVICE, AND STORAGE MEDIUM FOR GENERATING A MEDIA CONTENT’, which is incorporated herein by reference in its entirety.

### FIELD

Example embodiments of the present disclosure generally relate to the field of computers, and in particular, to media content generation.

### BACKGROUND

In recent years, with the development of the Internet, more and more users post media contents in a network platform. Some creating tools, for example, may support the user editing an existing media content, some creating tools also capable of supporting creating a media content based on a plurality of media materials.

### SUMMARY

In a first aspect of the present disclosure, a method of media content generation is generated, including: determining a set of reference media contents for media content generation, the set of reference media contents being determined from a media library associated with a user; and presenting a target media content generated based on the set of reference media contents, the target media content including at least one foreground element superimposed on a background image, wherein a foreground element includes an image segment determined by segmenting a corresponding reference media content of the set of reference media contents.

In a second aspect of the present disclosure, an apparatus for generating a media content is provided. The apparatus includes: a determining module configured to determine a set of reference media contents for media content generation, the set of reference media contents being determined from a media library associated with a user; and a presenting module configured to present a target media content generated based on the set of reference media contents, the target media content including at least one foreground element superimposed on a background image, wherein a foreground element includes an image segment determined by segmenting a corresponding reference media content of the set of reference media contents.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar drawing identification refer to the same or similar elements, wherein:

FIG. 1 illustrates a schematic diagram of an example environment in which embodiments od the present disclosure may be implemented in-time;

FIGS. 2A-2H illustrate example interfaces according to some embodiments of the present disclosure;

FIG. 3 illustrates a flowchart of an example process for media content generation according to some embodiments of the present disclosure;

FIG. 4 illustrates a schematic structural block diagram of an example apparatus for media content generation according to some embodiments of the present disclosure; and

FIG. 5 illustrates a block diagram of an electronic device capable of implementing a plurality of embodiments of the present disclosure.

### DETAILED DESCRIPTION

Embodiments of the present disclosure will be described in greater detail below with reference to the accompanying drawings. Although certain embodiments of the present disclosure are illustrated in the accompanying drawings, it would be appreciated, however, that the present disclosure may be implemented in a variety of forms and would not be construed as being limited to the embodiments set forth herein; rather, these embodiments are provided for the purpose of providing a more thorough and complete understanding of the present disclosure. It would be appreciated that the accompanying drawings and embodiments of the present disclosure are for example purposes only and are not intended to limit the scope of protection of the present disclosure.

It would be noted that any section/subsection headings provided herein are not limiting. Various embodiments are described throughout this document, and any type of embodiment may be included under any section/subsection. In addition, embodiments described in any section/subsection may be combined in any manner with any other embodiments described in the same section/subsection and/or in a different section/subsection.

In the description of embodiments of the present disclosure, the term “including” and its equivalents are to be understood as open-endedly inclusive, i.e., “including but not limited to”. The term “based on” is to be understood as “at least partially based on”. The term “an embodiment” or “the embodiment” is to be understood as “at least one embodiment”. The term “some embodiments” is to be understood as “at least some embodiments”. Other definitions, both explicit and implicit, may be included below. The terms “first”, “second”, etc. may refer to different or identical objects. Other definitions, both explicit and implicit, may be included below.

Embodiments of the present disclosure may involve user data, obtaining and/or using data, etc. These aspects follow the corresponding laws and regulations and related provisions. In the embodiments of the present disclosure, all data acquisition, obtaining, processing, handling, forwarding, use, and the like are carried out on the premise of the user's knowledge and acknowledgment. Accordingly, in implementing the embodiments of the present disclosure, the type, scope of use, usage scenario, etc., of the data or information that may be involved would be notified to the user and the user's creation would be obtained in an appropriate manner in accordance with the relevant laws and regulations. The specific manner of informing and/or authorizing may vary according to the actual situation and application scenario, and the scope of the present disclosure is not limited in this regard.

In this specification and the programs in the examples, if personal information is processed, it will be processed on the basis of legality (e.g., with the consent of the subject of the personal information, or necessary for the fulfillment of a contract, etc.), and it will be processed only within the scope of the regulations or agreements. The refusal of the user to process personal information other than that which is necessary for the basic functions will not affect the use of the basic functions.

As briefly mentioned above, with the development of the Internet, more and more users post media contents in network platforms. When posting a media content, a user desires to create a media content based on a plurality of media materials. However, in a process of media content generation, an existing network platform may only perform a simple combination on a picture or generate a complex video based on a picture.

The embodiments of the present disclosure provide a scheme for generating a media content. According to this aspect, a set of reference media contents for media content generation may be determined, the set of reference media contents being determined from a media library associated with a user; and a target media content generated is presented based on the set of reference media contents, the target media content including at least one foreground element superimposed on a background image, wherein a foreground element includes an image segment determined by segmenting a corresponding reference media content of the set of reference media contents.

In this way, the embodiments of the present disclosure may determine a reference media content from a media library of a user, determine a background image based on the reference media content, and segment at least one foreground element, thereby generating a target media content.

In this way, the embodiments of the present disclosure may help the user to remove a media material from a reference media content, improving the efficiency of processing the media content by the user, and saving the time of the user. In addition, in the embodiments of the present disclosure, based on the media material extracted from the reference media content as the at least one foreground element, and the at least one foreground element is superimposed on the background image to generate a target media content, the editing cost of the user in this manner is reduced.

In addition, because the target media content generated by the embodiments of the present disclosure presents at least one foreground element in the same background image, only a core element in the reference media content is retained compared with the media content generated based on a traditional puzzle mode or a graph-generation video mode, and irrelevant features are removed. Therefore, the target media content generated by the embodiment of the present disclosure is higher in quality and better in presenting effect.

Various example implementations of this scheme are described in detail below in conjunction with the accompanying drawings.

### Example Environment

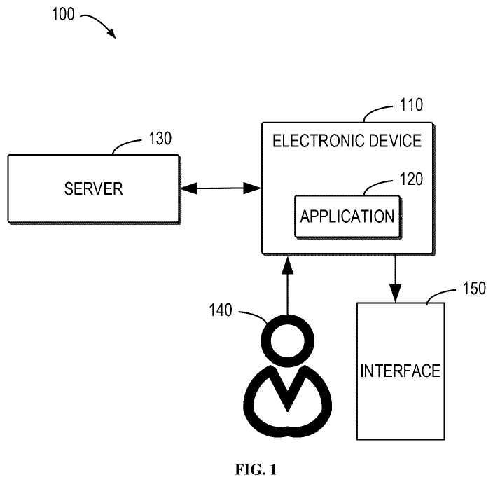

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to, video applications, social applications, or other suitable applications. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster composed of a plurality of physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example of Media Content Generation

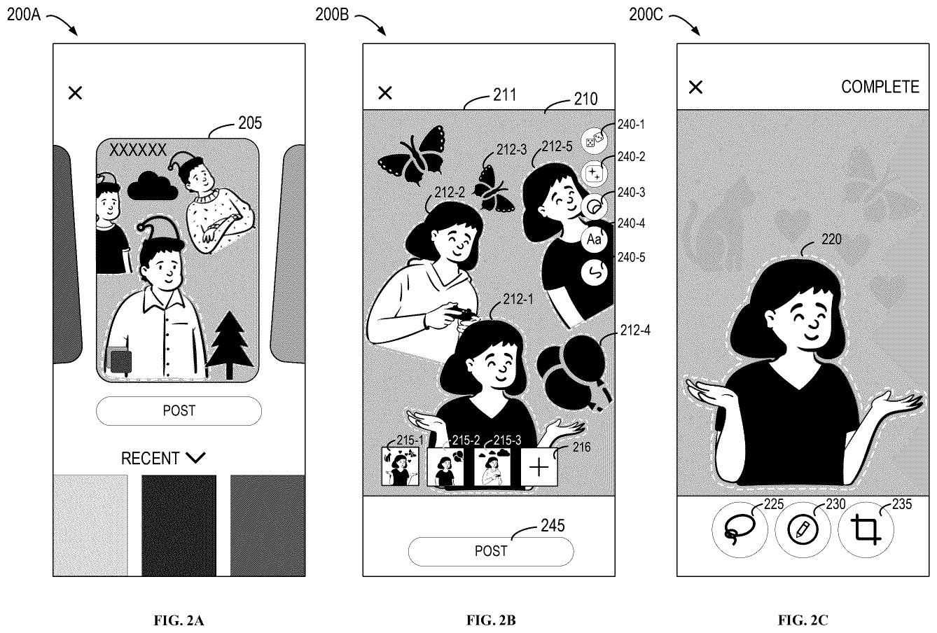

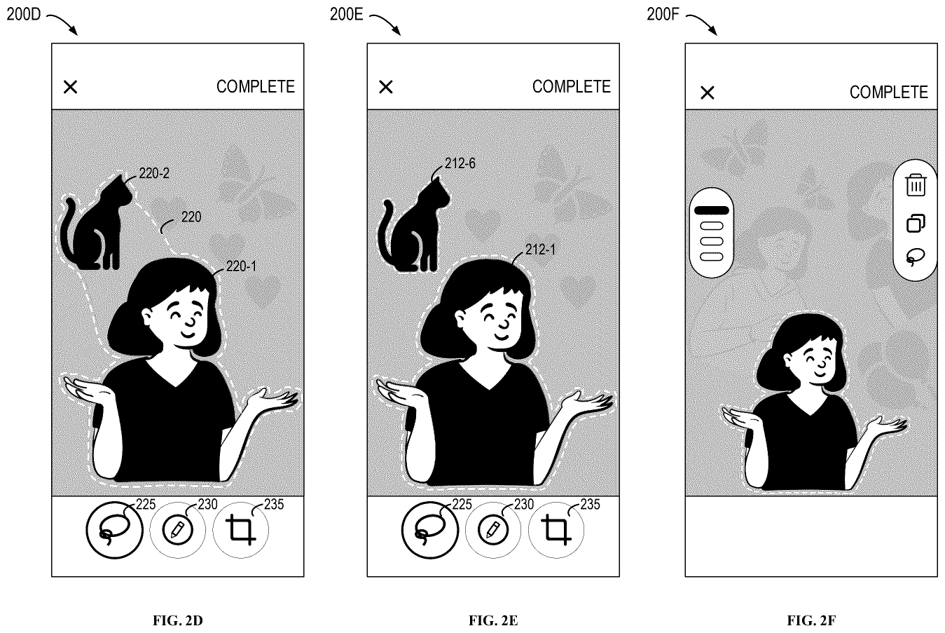

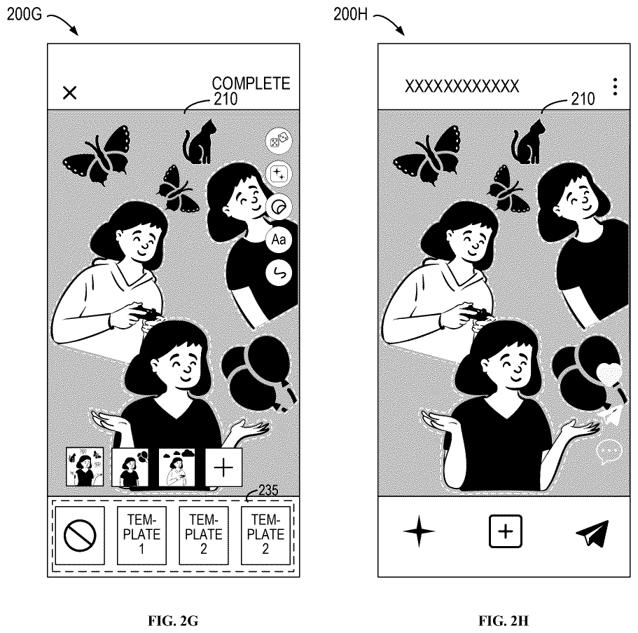

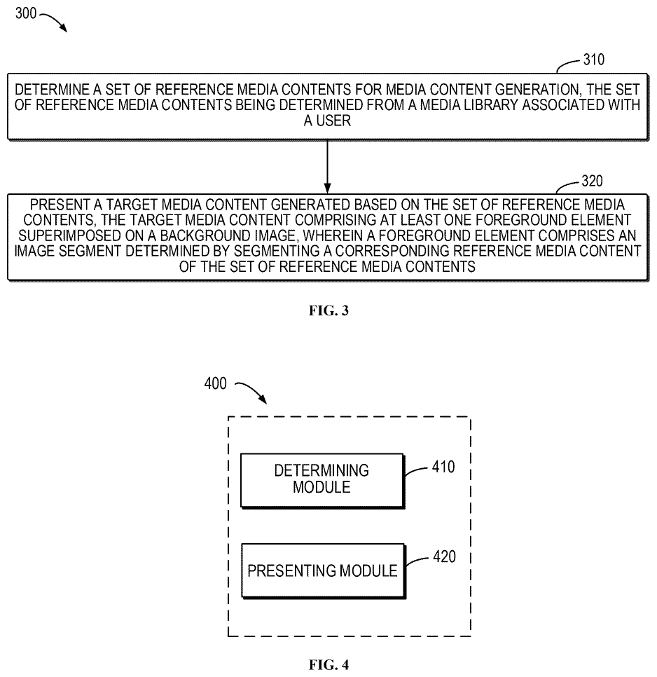

FIGS. 2A-2H illustrate example interfaces 200A-200H according to some embodiments of the present disclosure. The interface 200A to an interface 200H may be provided, for example, by the electronic device 110 shown in FIG. 1.

In some embodiments, as shown in FIG. 2A, the electronic device 110 may present a target media content 205 in the target interface 200A. As an example, the electronic device 110 may, in response to a trigger for the media library (e.g., open an album), present the target interface 200A.

In some embodiments, with continued reference to FIG. 2A, the target media content 205 may be generated based on a set of reference media contents. As an example, a set of reference media contents is determined from a media library associated with a user. As an example, a media library associated with a user may include a local album, a cloud album of the user, and/or a further hardware or software application that may store media contents of the user.

In some embodiments, the electronic device 110 may receive a request to generate a media content. Further, the electronic device 110 may, in response to the generation request, determine the set of reference media contents associated with a predetermined topic from the media library. As an example, the predetermined topic may include one or more topics.

As an example, the predetermined topic may include a time topic, an event topic, and/or an object topic. As an example, the time topic may correspond to a predetermined time period, for example, a day, a week, or the like. As an example, the event topic may include a holiday topic (e.g., spring festival, Christmas, etc.), a travel topic (e.g., XXX travel diary), or a food topic (e.g., XXX local meals), etc. As an example, the object topic may include a person object (e.g., a user selfie), an animal object (e.g., a cat), or a further object (e.g., sunrise, sea), or the like.

In some embodiments, with continued reference to FIG. 2A, the electronic device 110 may determine a set of reference media contents associated with a “Christmas topic” from the media library based on an event topic (e.g., the “Christmas topic”). Further, the electronic device 110 and/or the server 130 may generate the target media content 205 based on a set of reference contents associated with the “Christmas topic”.

In some embodiments, the electronic device 110 may present a media selection interface. The media selection interface displays a plurality of media contents in the media library. As an example, the electronic device 110 may, in response to receiving a predetermined operation of the user (for example, a click operation on a control associated with the media selection interface, etc.), present the media selection interface. Further, the electronic device 110 may receive, via the media selection interface, a selection of the set of reference media contents of the plurality of media content, to determine the set of reference media contents.

In some embodiments, as shown in FIG. 2B, the electronic device 110 may present the target media content 210 in an editing interface 200B. As an example, the target media content 210 may be generated based on a set of reference media contents selected from the media selection interface. It would be appreciated that target media content 210 may be generated by electronic device 110, server 130, and/or other suitable electronic device or combination.

As an example, the electronic device 110 may, in response to a set of reference media contents being determined via the media selection interface, present the editing interface 200B. As an example, the electronic device 110 may also, in response to a set of reference media contents being determined from the media library based on a predetermined topic, present the editing interface 200B.

In some embodiments, with continued reference to FIG. 2B, the electronic device 110 may provide a media control 216 in the editing interface 200B. Further, the electronic device 110 may, in response to a trigger for the media control 216, present a media selection interface to add a reference media content via the media selection interface.

In some embodiments, with continued reference to FIG. 2B, the target media content 210 may include a background image 211 and at least one foreground element superimposed on the background image 211. As an example, the at least one foreground element may include a foreground element 212-1, a foreground element 212-2, a foreground element 212-3, a foreground element 212-4, and a foreground element 212-5, etc.

In some embodiments, the at least one foreground element may include: a static image content and/or a dynamic image content. As an example, the dynamic image content may include a dynamic picture and a video content.

In some embodiments, the foreground element may include an image segment determined by segmenting the reference media content. As an example, the electronic device 110 or the server 130 may use the image processing model to segment an image segment corresponding to a predetermined object from the reference media content as the foreground element. Such objects may include any suitable type of object, e.g., a person, an animal, a building, a food, or the like. As an example, the image processing model may be implemented as a machine learning model having an image segmenting capability. The present disclosure is not intended to limit the specific content and training process of the image processing model.

In some embodiments, the image segment may include determining a first image segment determined from a reference media content based on a first editing operation of the user. As an example, the first editing operation may indicate a first region to be segmented. As an example, the electronic device 110 may determine, based on the first editing operation (e.g., scribing, framing, etc.) of the reference media content by the user, a first region to be segmented in the reference media content to determine a first image segment based on the first region.

In some embodiments, the image segment may include a second image segment. The second image segment is determined by segmenting a second region, from a reference media content, corresponding to a predetermined object. As an example, the predetermined object may include a set of reference media contents (for example, a person image in a portrait photo), an animal image (for example, an animal image in a photo), or a topic object associated with a predetermined topic (for example, a Christmas tree, a Christmas gift, a Christmas hat, and the like associated with Christmas). As an example, the electronic device 110 or the server 130 associated with the electronic device 110 may segment (or recognize) the second region corresponding to the predetermined object from the set of reference media contents with the image recognition model to determine the second image segment. As an example, the image recognition model may be implemented as a machine learning model with a recognition image capability. The present disclosure is not intended to limit the specific content and training process of the image recognition model.

In some embodiments, the electronic device 110 and/or the server 130 may determine style information corresponding to the at least one foreground element, the style information indicated at least one display attribute of the at least one foreground element. Further, the electronic device 110 and/or the server 130 may superimpose, based on the style information, the at least one foreground element to the background image to generate the target media content.

In some embodiments, the at least one display attribute may include a display position of a foreground element, a display size of a foreground element, a display direction of a foreground element, and/or a display hierarchy of a foreground element.

In some embodiments, the electronic device 110 and/or the server 130 may determine style information for the at least one foreground element with a template. Specifically, the electronic device 110 and/or the server 130 may determine a first template to be applied. The first template may include: a predetermined template, a template selected by the user, or a template determined based on the at least one foreground element. As an example, the electronic device 110 and/or the server 130 may determine the first template based on a selection of the user. Alternatively, the electronic device 110 and/or the server 130 may also use a predetermined template. In some embodiments, the electronic device 110 and/or the server 130 may further use the template determined based on the at least one foreground element as the first template. Further, the electronic device 110 and/or the server 130 may determine, based on the first template to be applied, the style information corresponding to the at least one foreground element.

As an example, the predetermined template may include a template corresponding to default style information. As an example, the electronic device 110 may provide a plurality of candidate templates for the user. Further, the electronic device 110 may use the template selected from the plurality of candidate templates by the user as a first template. As an example, the electronic device 110 and/or the server 130 may match a corresponding template from the plurality of candidate templates based on the content information of the at least one foreground element as the first template. As an example, the electronic device 110 and/or the server 130 may match a template related to Christmas tree from the plurality of candidate templates as the first template based on the content (e.g., Christmas tree, Christmas hat, etc.) associated with Christmas section in the at least one foreground element.

In some embodiments, the at least one display attribute of the at least one foreground element satisfies a predetermined display constraint, and the display constraint at least indicates an occlusion relationship between elements. As an example, the occlusion relationship may, for example, ensure an integrity of the content presented by the foreground element (for example, the face is not shielded). As an example, the display constraint may also indicate an association between the at least one foreground element (e.g., the white cloud image and the solar image may be closer together, the white cloud image may be farther away from the grassland image). In this way, at least one foreground element in the target media content generated by the embodiments of the present disclosure may be associated with each other, thereby ensuring interestingness and content harmony of the target media content.

In some embodiments, the background image of the target media content may also be determined based on the set of reference media contents. In some embodiments, the electronic device 110 and/or the server 130 may determine the first media content satisfying a predetermined condition from the set of reference media contents. Further, the background image is determined based on a first reference media content. As an example, the predetermined condition satisfied by the first media content includes: the first media content has fewer elements and more white space. As an example, an image of a blue sky with a single element and a large portion of white space in the image (e.g., a large blue sky, etc.) satisfies the predetermined conditions. For illustrative purposes only, in addition to a blue sky, a wall, a monochromatic image, a lake, or an image with fewer elements (e.g., to facilitate the removal of distracting elements), etc., all satisfy the predetermined conditions.

In some embodiments the background image may include at least part of the first reference media content. As an example, the background image may include a partial region in a certain photo.

In some embodiments, with continued reference to FIG. 2B, the electronic device 110 may present a set of reference media contents in the editing interface 200B. In some embodiments, the electronic device 110 may present a set of thumbnails corresponding to the set of reference media contents in the editing interface 200B. As an example, the set of thumbnails may include, for example, a thumbnail 215-1, a thumbnail 215-2, and a thumbnail 215-3.

In some embodiments, with continued reference to FIG. 2B, the foreground element includes an image segment determined by segmenting a corresponding reference media content of the set of reference media contents. As an example, the foreground element 212-1 includes an image segment segmented from the reference media content corresponding to the thumbnail 215-1.

In some embodiments, with continued reference to FIG. 2B, the at least one foreground element includes a third foreground element and a fourth foreground element, and the third foreground element and the fourth element may correspond to different image segments of the same reference media content. That is, one piece of reference media content may be divided into one or more foreground elements. As an example, the foreground element 212-1 and the foreground element 212-3 correspond to different image segments of the reference media content corresponding to the thumbnail 215-1.

In some embodiments, with continued reference to FIG. 2B, the electronic device 110 may, in response to a selection of a target thumbnail in the set of thumbnails, display, in the target media content 210, at least one foreground element corresponding to the target thumbnail differently. As an example, the electronic device 110 may, in response to a selection of the thumbnail 215-2, display, in the target media content 210, the foreground element 212-5 corresponding to the thumbnail 215-2 differentially. As an example, displaying the foreground element 212 differently may include displaying the foreground element 212-5 in highlight, reducing a transparency of further content other than the foreground element 212-5 in the target media content 210, or separately presenting the viewing interface of the foreground element 212-5, or the like.

In some embodiments, with continued reference to FIG. 2B, displaying, in the target media content, at least one foreground element corresponding to the target thumbnail differently may include: presenting, in the target media content, a contour element for indicating a border of the at least one foreground element. As an example, the electronic device 110 may display, in the target media content 210, a contour element indicating a border of the foreground element 212-5 (e.g., a contour line that may wrap the foreground element 212-5).

In some embodiments, with continued reference to FIG. 2B, the electronic device 110 may, in response to a first operation (e.g., a click or a long-press operation) on a first foreground element in the at least one foreground element, present a viewing interface of a first reference media content corresponding to the first foreground element.

In some embodiments, as shown in FIG. 2C, the electronic device 110 may, in response to a first operation on a first foreground element (e.g., the foreground element 212-1), present the viewing interface 200C of the reference media content corresponding to the first foreground element. The electronic device 110 may display, in the viewing interface 200C, an image segment 220 corresponding to the first foreground element (e.g., the foreground element 212-1) differently. As an example, the electronic device 110 may reduce the transparency other than the image segment 220 in the viewing interface 200C of the reference media content to highlight the image segment.

In some embodiments, with continued reference to FIG. 2C, the electronic device 110 may, in response to receiving a second editing operation in the viewing interface 200C, adjust the image segment 220 based on the second editing operation to update the first foreground element. As an example, as shown in FIG. 2C, the electronic device 110 may provide a first adjustment control 225.

In some embodiments, as shown in FIG. 2D, the electronic device 110 and/or the server 130 may adjust a region border corresponding to the image segment 220 based on the received second editing operation. Further, the electronic device 110 and/or the server 130 may determine a new image segment based on the adjusted region border. As an example, the electronic device 110 may receive an adjustment operation of the user based on the first adjustment control 225 to adjust a region border corresponding to the image segment 220. For example, before receiving the adjustment operation, the area corresponding to the image segment 220 only includes a first portion 220-1 (for example, a portrait portion); and after receiving the adjustment operation, the area corresponding to the new image segment 220 further includes a second portion 220-2 (for example, a small cat portion).

In some embodiments, as shown in FIG. 2E, the electronic device 110 and/or the server 130 may determine the existing foreground element 212-1 and a new foreground element 212-6 based on the new image segment 220. Further, the electronic device 110 may add a presentation of the foreground element 212-6 to the target media content.

In some embodiments, with continued reference to FIG. 2C, the electronic device 110 may provide a second adjustment control 235 (or a cropping control) in the viewing interface 200C. Further, the electronic device 110 may receive a cropping operation of the user based on the second adjustment control 235 to adjust the image segment 220.

In some embodiments, with continued reference to FIG. 2C, the second editing operation may also trigger the electronic device 110 to add at least one additional visual element in the image segment 220. As an example, the electronic device 110 may provide a brush control 230 in the viewing interface 200C. Further, the electronic device 110 and/or the server 130 may, obtain an additional visual element (e.g., an additional text content or an additional image content) input by the user based on the brush control 230 to present the additional visual element in the image segment 220.

In some embodiments, with continued reference to FIG. 2B, the electronic device 110 may, in response to a second operation for a second foreground element in the at least one foreground element, display the second foreground element differentially in the target media content 210.

In some embodiments, as shown in FIG. 2F, the electronic device 110 may, in response to a predetermined operation (e.g., a click or a long-press operation) on the second foreground element (e.g., the foreground element 212-1), display the second foreground element differentially in the target media content 210. For example, a transparency of further content other than foreground element 212-1 is reduced. Further, the electronic device 110 may, in response to a second operation (e.g., a click, a long press, or a trigger on a hierarchical control) of the user, adjust a display hierarchy of the second foreground element.

In some embodiments, with continued reference to FIG. 2B, the electronic device 110 may provide a position adjustment control 240-1 associated with the target media content in the editing interface 200B. Further, the electronic device 110 may, in response to a trigger for the position adjustment control 240-1, adjust a display position of the at least one foreground element (for example, based on a style randomly determined from a plurality of predetermined styles to adjust a display position of the at least one foreground element).

In some embodiments, with continued reference to FIG. 2B, the electronic device 110 may present a template control associated with the target media content 240-2 in the editing interface 200B. Further, the electronic device 110 may, in response to a trigger for the template control 240-2, present a set of predetermined templates.

In some embodiments, as shown in FIG. 2G, the electronic device 110 may present a set of predetermined templates 245 in the editing interface 200G. The set of predetermined templates 245 corresponds to a set of presenting styles. The presenting style may correspond to style information of the foreground element. Further, the electronic device 110 may, in response to a selection of a second template in the set of candidate templates 245, present an update media content generated based on the second template and the set of reference media contents. As an example, the updated media content may be generated based on style information corresponding to the second template and a set of reference media contents.

In some embodiments, with continued reference to FIG. 2B, the electronic device 110 may provide an adding entry 240-3 in the editing interface 200B of the target media content 210. Further, the electronic device 110 may, in response to a trigger for then adding entry 240-3, present a set of candidate materials. Further, the electronic device 110 may, in response to a selection of a target material in the set of candidate materials, add an additional foreground element corresponding to the target material to the target media content. As an example, a set of candidate materials may include historical materials (i.e., previously generated foreground elements). The set of candidate materials may also include further image contents (e.g., stickers, etc.).

In some embodiments, a set of candidate materials is associated with the material library. The electronic device 110 may, in response to a predetermined operation on the target media content, add at least one foreground element in the at least one foreground element in the target media content to the material library.

In some embodiments, with continued reference to FIG. 2B, the electronic device 110 may provide a text control 240-4. Further, the electronic device 110 may obtain a text content input by the user based on the text control 240-4, to present the input text content in the target media content 210.

In some embodiments, with continued reference to FIG. 2B, the electronic device 110 may provide a rendering control 240-5. Further, the electronic device 110 may obtain a line or image content drawn by the user based on the drawing control 240-5, to present the drawn line or image content in the target media content 210.

In some embodiments, with continued reference to FIG. 2B, the electronic device 110 may provide a posting control 245 in the editing interface 200B. Further, the electronic device 110 may, in response to a trigger for the posting control 245, present the target media content 210 in a content item interface of the information flow.

In some embodiments, as shown in FIG. 2H, the electronic device 110 may present the target media content 210 in the content item interface 200H of the information stream. The electronic device 110 may present poster information (e.g., avatar or nickname, etc.) of the target media content in the content item interface 200H. The electronic device 110 may present interaction information (e.g., like, comments, favorites, etc.) of the target media content 210 in the content item interface 200H.

In some embodiments, with continued reference to FIG. 2H, the electronic device 110 may display at least one foreground element differently. As an example, the electronic device 110 may display the at least one foreground element included in the target media content 210 in highlight based on presenting a contour element indicating a border of the at least one foreground element.

Based on the process described above, embodiments of the present disclosure may determine a reference media content from a media library of a user, determine a background image based on the reference media content, and segment at least one foreground element, thereby generating a target media content. Further, the embodiments of the present disclosure may further adjust a presenting style of the reference media content, the at least one foreground element, and/or the at least one foreground element based on the operation of the user.

In this way, the embodiments of the present disclosure are capable of generating a target media content including a plurality of hierarchical relationships for a user, as well as providing a simple and fast editing pathway for the user, which satisfies the requirement of the user for generating a e media content, and improves the quality and efficiency of generating a media content.

### Example Processes

FIG. 3 illustrates a flowchart of an example process 300 of medium content generation according to some embodiments of the present disclosure. The process 300 may be implemented at the electronic device 110. The process 300 is described below with reference to FIG. 1.

As shown, at block 310, the electronic device 110 determines a set of reference media contents for media content generation, the set of reference media contents being determined from a media library associated with a user.

At block 320, the electronic device 110 presents a target media content generated based on the set of reference media contents, the target media content including at least one foreground element superimposed on a background image, wherein a foreground element includes an image segment determined by segmenting a corresponding reference media content of the set of reference media contents.

In some embodiments, determining the set of reference media contents for media content generation includes: presenting a media selection interface displaying a plurality of media contents in the media library; and receiving, via the media selection interface, a selection of the set of reference media contents of the plurality of media content, to determine the set of reference media contents.

In some embodiments, determining the set of reference media contents for media content generation includes: receiving a generation request for generating a media content; and in response to the generation request, determining the set of reference media contents associated with a predetermined topic from the media library.

In some embodiments, the image segment includes: determining a first image segment determined from a reference media content based on a first editing operation of the user, the first editing operation indicating a first region to be segmented; or a second image segment determined by segmenting a second region, from a reference media content, corresponding to a predetermined object.

In some embodiments, the background image is determined based on the following: determining a first reference media content satisfying a predetermined condition from the set of reference media contents; and determining the background image based on the first reference media content, the background image including at least part of the first reference media content.

In some embodiments, the background image is determined based on the following: generating the background image based on the set of reference media contents.

In some embodiments, the target media content is generated based on the following: determining style information corresponding to the at least one foreground element, the style information indicating at least one display attribute of the at least one foreground element; and superimposing, based on the style information, the at least one foreground element to the background image to generate the target media content.

In some embodiments, the at least one display attribute includes at least one of the following: a display position of a foreground element, a display size of a foreground element, a display direction of a foreground element, or a display hierarchy of a foreground element.

In some embodiments, determining the style information corresponding to the at least one foreground element includes: determining a first template to be applied, wherein the first template includes: a predetermined template, a template selected by the user, or a template determined based on the at least one foreground element; and determining, based on the first template, the style information corresponding to the at least one foreground element.

In some embodiments, the at least one display attribute of the at least one foreground element satisfies a predetermined display constraint, the display constraint at least indicating an occlusion relationship between elements.

In some embodiments, the process 300 further includes: in response to a first operation on a first foreground element in the at least one foreground element, presenting a viewing interface of a first reference media content corresponding to the first foreground element; and displaying, in the viewing interface, an image segment corresponding to the first foreground element differently.

In some embodiments, the process 300 further includes: in response to receiving a second editing operation in the viewing interface, adjusting the image segment based on the second editing operation to update the first foreground element.

In some embodiments, adjusting the image segment based on the second editing operation includes: adjusting a border of the image segment; and/or adding at least one additional visual element in the image segment.

In some embodiments, the process 300 further includes: based on a second operation for a second foreground element in the at least one foreground element, adjusting a display hierarchy of the second foreground element in the target media content.

In some embodiments, the process 300 further includes: presenting an editing interface of the target media content; in response to a trigger for an adding entry in the editing interface, presenting a set of candidate materials; and in response to a selection of a target material in the set of candidate materials, adding an additional foreground element corresponding to the target material to the target media content.

In some embodiments, the set of candidate materials is associated with a material library, and the process 300 further includes: in response to a predetermined operation on the target media content, adding at least one foreground element in the at least one foreground element in the target media content to the material library.

In some embodiments, the process 300 further includes: presenting a position adjustment control associated with the target media content; and in response to a trigger for the position control, adjusting a display position of the at least one foreground element in the target media content.

In some embodiments, the process 300 further includes: presenting a template control associated with the target media content; in response to a trigger for the template control, presenting a set of candidate templates; and in response to a selection of a second template in the set of candidate templates, presenting an update media content generated based on the second template and the set of reference media contents.

In some embodiments, the at least one foreground element includes a third foreground element and a fourth foreground element corresponding to different image segments of a same reference media content.

In some embodiments, the process 300 further includes: presenting a set of thumbnails corresponding to the set of reference media content; and in response to a selection of a target thumbnail in the set of thumbnails, displaying, in the target media content, at least one foreground element corresponding to the target thumbnail differently.

In some embodiments, displaying, in the target media content, at least one foreground element corresponding to the target thumbnail differently includes: presenting, in the target media content, a contour element for indicating a border of the at least one foreground element

### Example Apparatus and Device

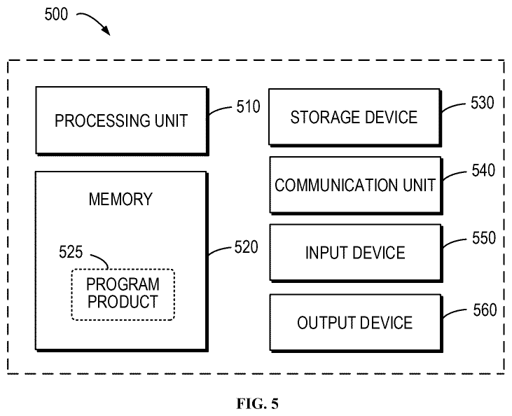

The embodiments of the present disclosure also provide a corresponding apparatus for implementing the above method or process. FIG. 4 shows a schematic structural block diagram of an example apparatus 400 for generating a media content according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a determining module 410 configured to determine a set of reference media contents for media content generation, the set of reference media contents being determined from a media library associated with a user; and a presenting module 420 configured to present a target media content generated based on the set of reference media contents, the target media content including at least one foreground element superimposed on a background image, wherein a foreground element includes an image segment determined by segmenting a corresponding reference media content of the set of reference media contents.

In some embodiments, the determining module 410 is further configured to: present a media selection interface displaying a plurality of media contents in the media library; and receive, via the media selection interface, a selection of the set of reference media contents of the plurality of media content, to determine the set of reference media contents.

In some embodiments, the determining module 410 is further configured to: receive a generation request for generating a media content; and in response to the generation request, determine the set of reference media contents associated with a predetermined topic from the media library.

In some embodiments, the image segment includes: determining a first image segment determined from a reference media content based on a first editing operation of the user, the first editing operation indicating a first region to be segmented; or a second image segment determined by segmenting a second region, from a reference media content, corresponding to a predetermined object.

In some embodiments, the background image is determined based on the following: determining a first reference media content satisfying a predetermined condition from the set of reference media contents; and determining the background image based on the first reference media content, the background image including at least part of the first reference media content.

In some embodiments, the background image is determined based on the following: generating the background image based on the set of reference media contents.

In some embodiments, the target media content is generated based on the following: determining style information corresponding to the at least one foreground element, the style information indicating at least one display attribute of the at least one foreground element; and superimposing, based on the style information, the at least one foreground element to the background image to generate the target media content.

In some embodiments, the at least one display attribute includes at least one of the following: a display position of a foreground element, a display size of a foreground element, a display direction of a foreground element, or a display hierarchy of a foreground element.

In some embodiments, determining the style information corresponding to the at least one foreground element includes: determining a first template to be applied, wherein the first template includes: a predetermined template, a template selected by the user, or a template determined based on the at least one foreground element; and determining, based on the first template, the style information corresponding to the at least one foreground element.

In some embodiments, the at least one display attribute of the at least one foreground element satisfies a predetermined display constraint, the display constraint at least indicating an occlusion relationship between elements.

In some embodiments, the apparatus 400 further includes a viewing module configured to: in response to a first operation on a first foreground element in the at least one foreground element, present a viewing interface of a first reference media content corresponding to the first foreground element; and display, in the viewing interface, an image segment corresponding to the first foreground element differently.

In some embodiments, the apparatus 400 further includes an editing module configured to: in response to receiving a second editing operation in the viewing interface, adjust the image segment based on the second editing operation to update the first foreground element.

In some embodiments, the editing module is further configured to: adjust a border of the image segment; and/or add at least one additional visual element in the image segment.

In some embodiments, the apparatus 400 further includes a hierarchy module configured to: based on a second operation for a second foreground element in the at least one foreground element, adjust a display hierarchy of the second foreground element in the target media content.

In some embodiments, the apparatus 400 further includes a material module configured to: present an editing interface of the target media content; in response to a trigger for an adding entry in the editing interface, present a set of candidate materials; and in response to a selection of a target material in the set of candidate materials, add an additional foreground element corresponding to the target material to the target media content.

In some embodiments, the set of candidate materials is associated with a material library, and the material module is further configured to: in response to a predetermined operation on the target media content, add at least one foreground element in the at least one foreground element in the target media content to the material library.

In some embodiments, the apparatus 400 further includes a position module configured to: present a position adjustment control associated with the target media content; and in response to a trigger for the position control, adjust a display position of the at least one foreground element in the target media content.

In some embodiments, the apparatus 400 further includes a template module configured to: present a template control associated with the target media content; in response to a trigger for the template control, present a set of candidate templates; and in response to a selection of a second template in the set of candidate templates, present an update media content generated based on the second template and the set of reference media contents.

In some embodiments, the at least one foreground element includes a third foreground element and a fourth foreground element corresponding to different image segments of a same reference media content.

In some embodiments, the apparatus 400 further includes a selecting module configured to: present a set of thumbnails corresponding to the set of reference media content; and in response to a selection of a target thumbnail in the set of thumbnails, display, in the target media content, at least one foreground element corresponding to the target thumbnail differently.

In some embodiments, the selecting module is further configured to: present, in the target media content, a contour element for indicating a border of the at least one foreground element.

FIG. 5 illustrates a block diagram of an electronic device 500 in which one or more embodiments of the present disclosure may be implemented. It would be appreciated that the electronic device 500 illustrated in FIG. 5 is merely for example and would not constitute any limitation on the functionality and scope of the embodiments described herein. The electronic device 500 illustrated in FIG. 5 may be used to implement the electronic device.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, a plurality of processing units execute computer-executable instructions in parallel to improve parallel processing capabilities of electronic device 500.

Electronic device 500 typically includes a plurality of computer storage media. Such media may be any available media accessible by the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any further medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, nonvolatile magnetic disk (e.g., a ‘floppy disk’) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various implementations of the present disclosure.

The communications unit 540 implements communications with further electronic devices over a communications medium. In addition, the function of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or a further network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) as needed, the external devices such as storage devices, display devices, etc., communicate with one or more devices that enable a user to interact with the electronic device 500, or communicate with any device (e.g., network card, modem, etc.) that enables the electronic device 500 to communicate with one or more further electronic devices. Such communication may be performed via an input/output (I/O) interface (not shown).

According to example implementations of the present disclosure, a computer-readable storage medium having computer-executable instructions stored thereon is provided, the computer program, when executed by a processor, causing the processor to implement the method described above. According to example implementations of the present disclosure, a computer program product is further provided, the computer program product being tangibly stored on a non-transitory computer-readable medium and including computer-executable instructions. The computer-executable instructions are executed by a processor to implement the method described above.

Aspects of the present disclosure are described herein with reference to flowcharts and/or block diagrams of a method, apparatus, device, and computer program product implemented in accordance with the present disclosure. It would be appreciated that each block of the flowchart and/or block diagram, and combinations of blocks in the flowcharts and/or block diagrams, may be implemented by computer readable program instructions.

These computer-readable program instructions may be provided to the processing unit of a general-purpose computer, a special-purpose computer, or other programmable data-processing device so as to produce a machine such that the instructions, when executed through the processing unit of the computer or other programmable data-processing apparatus, produce a device that implements the functions/actions specified in one or more blocks in the flowchart and/or block diagram. It is also possible to store these computer-readable program instructions in a computer-readable storage medium that causes the computer, programmable data processing apparatus and/or other device to content item in a particular manner, whereby the computer-readable medium with the instructions stored then includes an article of manufacture including instructions for implementing aspects of the function/action specified in the flowchart and/or the one or more blocks in the block diagram.

The computer-readable program instructions may be loaded onto a computer, further programmable data processing apparatuses, or further apparatuses, such that a series of operational steps are performed on a computer, further programmable data processing apparatuses, or further devices to produce a computer-implemented process. Thereby, instructions executed on a computer, further programmable data processing apparatus, or other device are made to implement the functions/actions specified in one or more of the blocks in the flowchart and/or block diagram.

The flowcharts and block diagrams in the accompanying drawings show the architecture, functions, and operations that may be implemented in a plurality of implemented system, method, and computer program products in accordance with the present disclosure. At this point, each block in the flowcharts or block diagrams may represent a module, program segment, or portion of an instruction, and the module, program segment, or portion of an instruction includes one or more executable instructions for implementing a specified logical function. In some implementations as replacements, the functions labeled in the blocks may also occur in a different order than that labeled in the accompanying drawings. For example, two consecutive blocks may actually be executed substantially in parallel, and they may sometimes be executed in reverse order, depending on the function involved. It would also be noted that each block in the block diagram and/or flowchart, and combinations of blocks in the block diagram and/or flowchart, may be implemented with a specialized hardware-based system that performs the specified function or action, or may be implemented with a combination of specialized hardware and computer instructions.

Various embodiments in the present disclosure have been described above, and the foregoing description is for example, is not exhaustive, and is not limited to the disclosed embodiments. Without departing from the scope and spirit of the illustrated implementations, many modifications and changes will be apparent to those of ordinary skill in the art. The terminology used herein has been chosen to best explain the principles of the implementations, practical applications or improvements to technology in the marketplace, or to enable others of ordinary skill in the art to understand the various implementations disclosed herein.

What is claimed is:

1. A method of media content generation, comprising:
determining a set of reference media contents for media content generation, the set of reference media contents being determined from a media library associated with a user; and
presenting a target media content generated based on the set of reference media contents, the target media content comprising at least one foreground element superimposed on a background image, wherein a foreground element comprises an image segment determined by segmenting a corresponding reference media content of the set of reference media contents.

2. The method of claim 1, wherein determining the set of reference media contents for media content generation comprises:
presenting a media selection interface displaying a plurality of media contents in the media library; and
receiving, via the media selection interface, a selection of the set of reference media contents of the plurality of media content, to determine the set of reference media contents.

3. The method of claim 1, wherein determining the set of reference media contents for media content generation comprises:
receiving a generation request for generating a media content; and
in response to the generation request, determining the set of reference media contents associated with a predetermined topic from the media library.

4. The method of claim 1, wherein the image segment comprises:
determining a first image segment determined from a reference media content based on a first editing operation of the user, the first editing operation indicating a first region to be segmented; or
a second image segment determined by segmenting a second region, from a reference media content, corresponding to a predetermined object.

5. The method of claim 1, wherein the background image is determined based on the following:
determining a first reference media content satisfying a predetermined condition from the set of reference media contents; and
determining the background image based on the first reference media content, the background image comprising at least part of the first reference media content.

6. The method of claim 1, wherein the background image is determined based on the following:
generating the background image based on the set of reference media contents.

7. The method of claim 1, wherein the target media content is generated based on the following:
determining style information corresponding to the at least one foreground element, the style information indicating at least one display attribute of the at least one foreground element; and
superimposing, based on the style information, the at least one foreground element to the background image to generate the target media content,
wherein the at least one display attribute of the at least one foreground element satisfies a predetermined display constraint, the display constraint at least indicating an occlusion relationship between elements.

8. The method of claim 7, wherein the at least one display attribute comprises at least one of the following:
a display position of a foreground element,
a display size of a foreground element,
a display direction of a foreground element, or
a display hierarchy of a foreground element.

9. The method of claim 7, wherein determining the style information corresponding to the at least one foreground element comprises:
determining a first template to be applied, wherein the first template comprises: a predetermined template, a template selected by the user, or a template determined based on the at least one foreground element; and
determining, based on the first template, the style information corresponding to the at least one foreground element.

10. The method of claim 1, further comprising:
in response to a first operation on a first foreground element in the at least one foreground element, presenting a viewing interface of a first reference media content corresponding to the first foreground element; and
displaying, in the viewing interface, an image segment corresponding to the first foreground element differently.

11. The method of claim 10, further comprising:
in response to receiving a second editing operation in the viewing interface, adjusting the image segment based on the second editing operation to update the first foreground element,
wherein adjusting the image segment based on the second editing operation comprises:
adjusting a border of the image segment; and/or
adding at least one additional visual element in the image segment.

12. The method of claim 1, further comprising:
based on a second operation for a second foreground element in the at least one foreground element, adjusting a display hierarchy of the second foreground element in the target media content.

13. The method of claim 1, further comprising:
presenting an editing interface of the target media content;
in response to a trigger for an adding entry in the editing interface, presenting a set of candidate materials; and
in response to a selection of a target material in the set of candidate materials, adding an additional foreground element corresponding to the target material to the target media content,
wherein the set of candidate materials is associated with a material library, and the method further comprises:
in response to a predetermined operation on the target media content, adding at least one foreground element in the at least one foreground element in the target media content to the material library.

14. The method of claim 1, further comprising:
presenting a position adjustment control associated with the target media content; and
in response to a trigger for the position control, adjusting a display position of the at least one foreground element in the target media content.

15. The method of claim 1, further comprising:
presenting a template control associated with the target media content;
in response to a trigger for the template control, presenting a set of candidate templates; and
in response to a selection of a second template in the set of candidate templates, presenting an update media content generated based on the second template and the set of reference media contents.

16. The method of claim 1, wherein the at least one foreground element comprises a third foreground element and a fourth foreground element corresponding to different image segments of a same reference media content.

17. The method of claim 1, further comprising:
presenting a set of thumbnails corresponding to the set of reference media content; and
in response to a selection of a target thumbnail in the set of thumbnails, displaying, in the target media content, at least one foreground element corresponding to the target thumbnail differently.

18. The method of claim 17, wherein displaying, in the target media content, at least one foreground element corresponding to the target thumbnail differently comprises:
presenting, in the target media content, a contour element for indicating a border of the at least one foreground element.

19. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
determining a set of reference media contents for media content generation, the set of reference media contents being determined from a media library associated with a user; and
presenting a target media content generated based on the set of reference media contents, the target media content comprising at least one foreground element superimposed on a background image, wherein a foreground element comprises an image segment determined by segmenting a corresponding reference media content of the set of reference media contents.

20. A non-transitory computer-readable storage medium having a computer program stored thereon, the computer program being executable by a processor to perform acts comprising:
determining a set of reference media contents for media content generation, the set of reference media contents being determined from a media library associated with a user; and
presenting a target media content generated based on the set of reference media contents, the target media content comprising at least one foreground element superimposed on a background image, wherein a foreground element comprises an image segment determined by segmenting a corresponding reference media content of the set of reference media contents.
